(19) United States
(12) Patent Application Publication
(10) Pub. No.: US 2007/0017857 A1
(43) Pub. Date: Jan. 25, 2007

(54) Liquid disinfectant system for use with aerobic wastewater treatment plants

(76) Inventor: Jerry L. McKinney, Silsbee, TX (US)

Correspondence Address: C. JAMES BUSHMAN, 5718 WESTHEIMER, SUITE 1800, HOUSTON, TX, 77057, US

(21) Appl. No.: 11/503,034

(22) Filed: Aug. 11, 2006

Related U.S. Application Data
(63) Continuation-in-part of application No. 10/866,349, filed on Jun. 11, 2004.

(51) Int. Cl. B01D 17/12; B01D 35/14

(52) U.S. Cl. 210/86; 210/134; 210/194; 210/198.1; 210/205; 422/28; 422/33; 210/151

(57) ABSTRACT

An apparatus for treating wastewater with a liquid disinfectant comprising a vessel for wastewater, a pump in the vessel, a discharge conduit connected to the outlet of the pump for discharging water from the vessel, a first valve in the discharge conduit to control flow through the discharge conduit, a recirculation conduit connected to the pump discharge for recycling at least a portion of the wastewater discharged from the pump back into the vessel, a container for liquid disinfectant, a feedline connected to the container to feed disinfectant into the vessel, a second valve in the feedline to control the flow of disinfectant through the feedline and a control system connected to the pump and the first and second valves to selectively cause opening and closing of the first and second valves at desired intervals for predetermined periods of time and selectively activate the pump at desired times for predetermined periods of time.

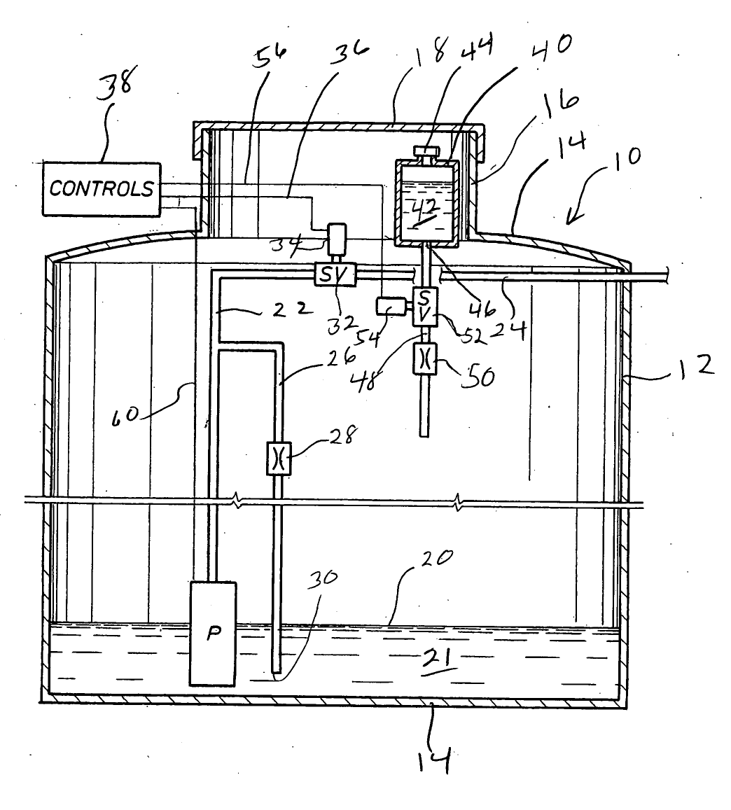

### CROSS REFERENCE TO RELATED APPLICATION

This application is a continuation-in-part of U.S. application Ser. No. 10/866,349 filed on Jun. 11, 2004, the disclosure of which is incorporated herein by reference.

### BACKGROUND OF THE INVENTION

1. Field of the Invention

The present invention relates to the treatment of wastewater from an aerobic wastewater treatment plant. More particularly, the present invention relates to a apparatus for disinfecting wastewater from an aerobic wastewater treatment plant using a liquid disinfectant.

2. Description of Prior Art

Aerobic wastewater treatment plants are commonly used in the United States in areas where there is a lack of municipal sewerage treatment and disposal. These generally small volume plants, e.g., flow rates of under 5,000 gallons per day, typically comprise a pretreatment vessel, an aerobic treatment chamber wherein the sewerage is initially subjected to bacterial action to break down the solids, a clarifier to allow residual solids to be removed from the aerobically digested sewerage to produce treated wastewater, and a discharge system which typically is in the form of a pump tank containing a discharge pump which can be used to discharge the treated water in the pump tank in a variety of ways, e.g., night spray systems, drip irrigation systems, discharge into a stream or the like.

Regardless of the method by which the water is finally discharged, most State and Federal regulations require that the water to be discharged be disinfected to eliminate or at least reduce the bacteria to an acceptable level. For this purpose, it has been common to use chlorinators, particularly chlorinators using tablets or other forms of solid, chlorine generating materials. It is also known to use liquid chlorinators wherein an amount of a liquid chlorine containing composition is injected into the clarified (treated) wastewater.

Typically liquid chlorinators have relied on the use of venturis or venturi-like pumps (venturi systems) to draw the liquid chlorine composition from a storage system into wastewater passing through the venturi system. An inherent problem with these venturi systems is that the wastewater passing there through is generally not totally free of solids. Since typically the nozzles of venturi systems have small diameter openings, there is a likelihood of plugging of the venturi with a concomitant disabling of the liquid chlorine composition infusion system. Examples of typical liquid chlorinators or liquid disinfectant systems employing the aspirating phenomena of venturi systems include U.S. Pat. Nos. 3,996,139; 4,019,983; 6,627,071 and 6,932,912.

### SUMMARY OF THE INVENTION

In one aspect, the present invention provides an apparatus for disinfecting wastewater with liquid disinfectant comprising a vessel for wastewater; a pump disposed in the vessel and having a pump discharge; a discharge conduit having an outlet and operatively connected to the pump discharge for discharging water from the vessel; a first valve in the discharge conduit selectively operable to open and close to control flow through the discharge conduit; a recirculation conduit operatively connected to the pump discharge for recycling a portion of the wastewater discharged from the pump back into the vessel; a container for liquid disinfectant; a feedline connected to the container to feed liquid disinfectant into the vessel; a second valve in the feedline selectively operable to open and close to control flow of disinfectant through the feedline; and a control system operatively connected to the pump and the first and second valves, the control systems serving to selectively cause opening and closing of the first and second valves at desired times and for predetermined periods of time and to selectively activate the pump at desired times and for predetermined periods of time.

### BRIEF DESCRIPTION OF THE DRAWINGS

The single FIGURE is an elevational, schematic view of one embodiment of the present invention.

### DETAILED DESCRIPTION OF PREFERRED EMBODIMENTS

Referring to the drawing, there is shown a vessel 10 having a cylindrical side wall 12, a generally, planar bottom wall 14 and a dome shaped top wall 14 provided with a cylindrical neck 16 which is covered by a removable hatch 18. It will be understood that vessel 10 is what is commonly referred to as a pump tank and in which wastewater which has been aerobically treated in a vessel (not shown) is introduced for temporary storage and subsequent pumping to a drain field, sprinkler system, etc. Thus, although not shown, it will be appreciated that there is an inlet to vessel 10 whereby water from the aeration or aerobic treatment tank can be introduced into vessel 10.

Disposed in vessel 10 is a pump P which as shown is partially below the level 20 of the wastewater 21 in vessel 10. Pump P has a pump discharge which is connected to a discharge conduit 22 which as seen has a branch 24 which extends out of vessel 10 and can be connected to a sprinkler system, drain field or other means of disposal. Connected to discharge conduit 22 is a recirculation conduit 26, there being a flow restrictor 28 in discharge conduit 26. It will thus be seen that when pump P is activated and pumping water through discharge conduit 22, a portion of the water will pass through recirculation conduit 26, through flow restrictor 28 and back into the wastewater in vessel 10. Recirculation of at least a portion of the wastewater is desirable since it circulates the wastewater 21, preventing or minimizing settling of solids in vessel 10. Additionally, it ensures thorough mixing of disinfectant introduced in vessel 10 with the wastewater 21 before the wastewater 21 is discharged. In this regard, it is to be noted that the bottom open end 30 of recirculation conduit 26 is below the level 20 of the wastewater 21 in vessel 10 although it could be above the level 20 of wastewater 21. Flow restrictor 28 can take many forms including a throttling valve such that the desired amount of wastewater is recirculated in the system to create sufficient turbulence to avoid solids settling and efficient mixing of the disinfectant with the wastewater.

Discharge line 22 passes through a solenoid valve 32 provided with an actuator 34. Actuator 34 of solenoid valve 32 is connected via a line 36 to a controller 38 described more fully hereafter. However, it will be understood the controller 38 via actuator 34 can control the position of solenoid valve 32, i.e., whether it is in the open or closed position, to thereby control the flow of wastewater discharge through the branch line 24 of discharge conduit 22.

Disposed in vessel 10 is a container 40 having a volume of liquid disinfectant 42 therein. The type of liquid disinfectant 42 is irrelevant as many various chemical compositions can be employed. Container 40 has a removable cap 44 to allow replenishment of liquid disinfectant 42 when needed, contains 40 being accessed through the neck 16 when batch 18 is removed. Although shown disposed in vessel 10 it will be appreciated that container 40 could be outside of vessel 10 if desired. Container 40 has an opening 46 in the bottom thereof which is connected to a feedline 48 which extends into vessel 10. Disposed in feedline 48 is a flow restrictor 50 and a solenoid valve 52 which is connected to an actuator 54. The actuator 54 in turn is connected via a line 56 to controllers 38. As in the case of solenoid valve 32, controller 38 via actuator 54 can control the position of valve 52, i.e., open or closed. Also connected to controller 38 via line 60 is pump P. Thus, via controller 38, pump P can be turned on and off at desired times and for desired time intervals as dictated by controller 38.

To disinfect the wastewater 21 in vessel 10, it is necessary that at least 3 requirements be met—sufficient liquid disinfectant 42 must be introduced into vessel 10; there must be adequate mixing of the disinfectant 42 with wastewater 21; and there must be sufficient residence time to allow the disinfectant 42 to properly treat remaining bacteria in wastewater 21. All of the above criteria can be achieved by the present invention.

Assume that wastewater 21 has been received in vessel 10 but that no disinfectant 42 has been introduced. The following, of several, scenarios could then take place. Solenoid valve 32 would be closed so that there would be no flow out of vessel 10 via discharge line 22. Solenoid valve 52 would be opened via controller 38 and actuator 54 whereby disinfectant 42 would be introduced into vessel 10. It will be understood that pump P could be operative while disinfectant 42 is being introduced into vessel 10 albeit that solenoid valve 32 is closed. In this regard, pump P would simply be recirculating wastewater 21 through recirculation conduit 26, no wastewater 21 being discharged from the vessel 10. Alternatively, and if desired, pump P could be inoperative while disinfectant 42 was being added such that no recirculation through conduit 26 was occurring. In any event, once the desired amount of disinfectant 42 had been introduced into vessel 10, and this would normally be determined by the opening of flow restrictor 50 and the amount of time that solenoid valve 52 remained open, valve 52 would be closed and pump P, if it was not already in an operating mode, would be activated by controller 38, solenoid valve 32 remaining closed, such that the mixture of disinfectant 42 and wastewater 21 would be thoroughly mixed via recirculation through recirculation conduit 26. This mixing of disinfectant 42 and wastewater 21 would occur for a predetermined amount of time which would ensure thorough mixing of disinfectant 42 and wastewater 21 as well as adequate residence time, i.e., contact between disinfectant 42 and wastewater 21. It will be understood that pump P could be activated for a desired amount of time to achieve thorough mixing and deactivated and the necessary adequate residence time achieved with the mixture of disinfectant 42 and wastewater 21 in the quiescent state. In other words, it is not necessary that pump P be running for the duration of time needed to achieve reduction of bacteria by disinfectant 42.

After sufficient mixing and residence time had been achieved, controller 38 via actuator 34 would then open solenoid valve 32 and activate pump P, if it was not already activated, such that the wastewater 21, now disinfected, would be discharged through conduit 22 and branch 24 to a drain field, etc., as described above.

It will be apparent from the above, that controller 38 can comprise a timer and suitable electronics, e.g., a chip, to activate and deactivate pump P and open and close valves 32 and 52 in any desired sequence at any desired times and for any desired predetermined amounts of time. For example, a typical cycle might be that with valve 32 closed, valve 52 would be opened for a period of 10 minutes during which disinfectant 42 is being introduced in the vessel 10. As noted above, pump P may or may not be running during this introduction of disinfectant 42. In any event, after the 10 minute introduction of disinfectant 42 had been completed, controller 38 would shut off valve 52 terminating introduction of disinfectant 42. At the same time, and again if pump P was not running, controller 38 could activate pump P for a period of 20 minutes to mix disinfectant 42 in wastewater 21. Pump P could then be deactivated and the mixture of disinfectant 42 and wastewater 21 allowed to remain quiescent for a further period of time to ensure sufficient residence time. It is also possible that controller 38 could intermittently activate and deactivate pump P during the cycle, i.e., when disinfectant 42 and wastewater 21 are being mixed during the span of the desired residence time. Once sufficient residence time had been achieved, controller 38 could then activate pump P and open valve 32 so that the now disinfected wastewater 21 could be discharged from vessel 10. Alternatively, even though sufficient residence time had been achieved, if it was not desired to discharge the disinfected contents of vessel 10, pump P could be kept in a deactivated state until such time as it was desired to discharge the contents of vessel 10. It may also be desirable if this period of time is lengthy, i.e., the time after sufficient residence time has been achieved and discharge is desired for controller 38 to intermittently turn pump P on and off to avoid excessive solids settling in vessel 10.

The foregoing description and examples illustrate selected embodiments of the present invention. In light thereof, variations and modifications will be suggested to one skilled in the art, all of which are in the spirit and purview of this invention.

What is claimed is:

1. An apparatus for treating wastewater with a liquid distinfectant comprising:
a vessel for wastewater;
a pump disposed in said vessel and having a pump discharge;
a discharge conduit having an outlet and operatively connected to said pump discharge for discharging water from said vessel;
a first valve in said discharge conduit selectively operable to open and close to control flow through said discharge conduit;
a recirculation conduit operatively connected to said pump discharge for recycling a portion of the wastewater discharged from said pump back into said vessel;
a container for liquid disinfectant;
a feedline connected to said container to feed liquid disinfectant into said vessel;
a second valve in said feedline selectively operable to open and close to control flow of disinfectant through said feedline; and
a control system operatively connected to said pump and said first and said second valves, said control system serving to selectively cause opening and closing of said first and second valves at desired times for predetermined periods of time and selectively activate said pump at desired times for predetermined periods of time.

2. The apparatus of claim 1, wherein said first and second valves comprise solenoid valves.

3. The apparatus of claim 1, wherein there is a flow restriction in said feedline.

4. The apparatus of claim 1, wherein there is a flow restrictor in said recirculation conduit.

5. The apparatus of claim 1, wherein said container is disposed inside of said vessel.
